(19) United States
(12) Patent Application Publication
(10) Pub. No.: US 2023/0264259 A1
(43) Pub. Date: Aug. 24, 2023

(54) Method for producing a machining segment with a projection of the hard material particles on the side surfaces of the machining segment

(71) Applicant: Hilti Aktiengesellschaft, Schaan (LI)

(72) Inventors: Thomas BRITT, Flums (CH); Jens STRACKE, Feldkirch (AT); Matthaeus HOOP, Eschen (LI); Jozsef SZABO, KECSKEMET (HU)

(21) Appl. No.: 18/010,636

(22) PCT Filed: Jun. 10, 2021
(86) PCT No.: PCT/EP2021/065622

§ 371 Date: Dec. 15, 2022

(30) Foreign Application Priority Data
Jun. 24, 2020 (EP) 20181945.5

(51) Int. Cl. B22F 3/12

(52) U.S. Cl. CPC B22F 3/12; B22F 2998/10

(57) ABSTRACT

Method for producing a machining segment (51) for a machining tool from a powdered or granular first matrix material (56), first hard material particles (57), which are arranged according to a defined first particle pattern, and second hard material particles (58), which are arranged according to a defined second particle pattern, the machining segment being connected by an underside (61) to a basic body of the machining tool. The machining segment (51) has on the side surfaces a projection of the second hard material particles (58) with respect to the first matrix material (56).

### TECHNICAL FIELD

The present invention relates to a method for producing a machining segment.

### BACKGROUND

Machining tools, such as core drill bits, saw blades, abrasive disks and cut-off grinding chains, comprise machining segments that are attached to a tubular, disk-shaped or annular basic body, the machining segments being connected to the basic body by welding, brazing or adhesive bonding. Depending on the machining method of the machining tool, machining segments that are used for core drilling are referred to as drilling segments, machining segments that are used for sawing are referred to as sawing segments, machining segments that are used for abrasive removal are referred to as abrading segments and machining segments that are used for cut-off grinding are referred to as cut-off grinding segments.

### SUMMARY OF THE INVENTION

Machining segments for core drill bits, saw blades, abrasive disks and cut-off grinding cutting chains are produced from a matrix material and hard material particles, where the hard material particles can be randomly distributed or are arranged according to a defined particle pattern in the matrix material. In the case of machining segments with randomly distributed hard material particles, the matrix material and the hard material particles are mixed, and the mixture is poured into a suitable mold and further processed to form the machining segment. In the case of machining segments with hard material particles arranged in a defined manner, a green body is built up in layers from matrix material, in which the hard material particles are arranged according to the defined particle pattern. In the case of machining segments that are to be welded to the basic body of the machining tool, the structure comprising a machining zone and a neutral zone has proven to be successful, since some combinations of matrix material and basic body cannot be welded. The machining zone is built up from a first matrix material and the neutral zone is built up from a second matrix material, which is different from the first matrix material and can be welded to the basic body.

In the case of machining tools which can be designed as a core drill bit, saw blade, abrasive disk or cut-off grinding chain and are intended for the wet or dry machining of concrete materials, increased wear on the side surfaces of the machining segments can occur as a result of friction with the substrate. The wear depends in particular on the wear properties of the first matrix material. It is known from EP 1 297 928 B1 to reduce wear on the side surfaces of the machining segments by second hard material particles which are admixed with the first matrix material as randomly distributed hard material particles. It is disadvantageous that the second hard material particles are completely embedded in the first matrix material. In order to expose the second hard material particles on the side surfaces, the machining segments must be sharpened on the side surfaces.

It is an object of the present invention to provide a method for producing a green body for a machining segment with which machining segments that have low wear on the side surfaces of the machining segments can be produced. Both in the production of the green body and in the further processing of the green body to form the machining segment, conventional tool components are to be used; the use of special tool components should be avoided. In addition, no re-working of the machining segments on the side surfaces should be required.

The method for producing a machining segment from a powdered or granular first matrix material, first hard material particles, which are arranged according to a defined first particle pattern, and second hard material particles, which are arranged according to a defined second particle pattern, is characterized according to the invention in that, when compacting the green body, a first film of a film material is arranged between the first press punch and the green body and a second film of the film material is arranged between the second press punch and the green body, the film material having a hardness which is less than the hardness of the first matrix material.

Machining segments that are produced by the method according to the invention are produced in a three-stage process: in a first stage, a green body is built up from the first matrix material, the first hard material particles and second hard material particles, the first and second hard material particles being arranged in the first matrix material according to a defined first and second particle pattern; in a second stage, the green body is compacted under the action of pressure to form a compact body and, in a third stage, the compact body is further processed under the action of temperature to form the machining segment.

Machining segments that are created by means of the method according to the invention for producing a machining segment have on the side surfaces a projection of the second hard material particles with respect to the first matrix material. The method according to the invention for producing a machining segment is distinguished by the fact that the green bodies are built up horizontally, the building-up direction runs perpendicularly to the vertical direction between the underside and upper side of the machining segment and, when compacting, a first and a second film of a film material is used, the hardness of the film material being less than the hardness of the first matrix material. The term “film material” includes all materials in film form that are suitable for producing a projection of the second hard material particles on the side surfaces of the machining segment. In order to be able to create the projection of the second hard material particles, the film material must have a hardness which is less than the hardness of the first matrix material.

The projection of the second hard material particles on the first and second side surfaces of the machining segments is created by means of the first film and the second film, the film material of the first and second films being different from the first matrix material. The first film is arranged between the first press punch, which forms the first side surface, and the green body, and the second film is arranged between the second press punch, which forms the second side surface, and the green body. Conventional press punches can be used as the first press punch and the second press punch; no special press punches with indentations in the pressing surface are required.

Preferably, the second hard material particles are completely embedded in the first matrix material on the first side surface and the second side surface when the green body is built up. The first film, which is arranged between the first press punch and the green body, and the second film, which is arranged between the second press punch and the green body, ensure that, after compaction, the second hard material particles have a projection with respect to the first matrix material on the first and second side surfaces. The method according to the invention has the advantage that the projection of the second hard material particles is created during the production of the machining segment and no re-working of the machining segments on the side surfaces is required.

In a first embodiment of the method, the first film and second film are removed from the compact body after compaction. When the first and second films are removed from the compact body after compaction, the compact body is further processed to form the machining segment by free-form sintering without further shaping.

In a second, alternative embodiment of the method, the compact body with the first film and second film are further processed to form the machining segment. When the compact body with the first film and second film are further processed to form the machining segment, the properties of the film material, in particular the melting temperature and the flash point, determine the behavior of the film material during further processing.

In a first variant, the film material is selected so that the melting temperature of the film material is lower than the sintering temperature of the first matrix material. If the melting temperature of the film material is lower than the sintering temperature of the first matrix material, the film material changes its state when it is heated up and liquefies before the first matrix material is sintered. The liquid film material distributes itself in the first matrix material during the sintering process and can support the sintering process as an infiltrate.

In a second variant, the film material is selected so that the flash point of the film material is lower than the sintering temperature of the first matrix material. If the flash point of the film material is lower than the sintering temperature of the first matrix material, the film material changes its state when it is heated up and evaporates before the first matrix material is sintered.

### BRIEF DESCRIPTION OF THE DRAWINGS

Exemplary embodiments of the invention are described hereinafter with reference to the drawing. It is not necessarily intended for this to illustrate the exemplary embodiments to scale; rather, the drawing is produced in a schematic and/or slightly distorted form where this is useful for purposes of explanation. It should be taken into account here that various modifications and alterations relating to the form and detail of an embodiment may be undertaken without departing from the general concept of the invention. The general concept of the invention is not limited to the exact form or the detail of the preferred embodiment shown and described hereinafter or limited to subject matter that would be restricted compared to the subject matter claimed in the claims. For given dimensioning ranges, values within the stated limits should also be disclosed as limit values and should be able to be used and claimed as desired. For the sake of simplicity, the same reference signs are used hereinafter for identical or similar parts or parts having an identical or similar function.

In the drawing:

FIGS. 1A, B show two variants of a machining tool designed as a core drill bit;

FIGS. 2A, B show two variants of a machining tool designed as a saw blade;

FIG. 3 shows a machining tool designed as an abrasive disk;

FIG. 4 shows a machining tool designed as a cut-off grinding chain;

FIGS. 5A-C show a machining segment produced by means of the method according to the invention, in which a green body (FIG. 5A) is compacted to form a compact body (FIG. 5B) and is further processed to form the machining segment (FIG. 5C); and

FIGS. 6A-C show a further machining segment produced by means of the method according to the invention, in which a green body (FIG. 6A) is compacted to form a compact body (FIG. 6B) and is further processed to form the machining segment (FIG. 6C).

### DETAILED DESCRIPTION

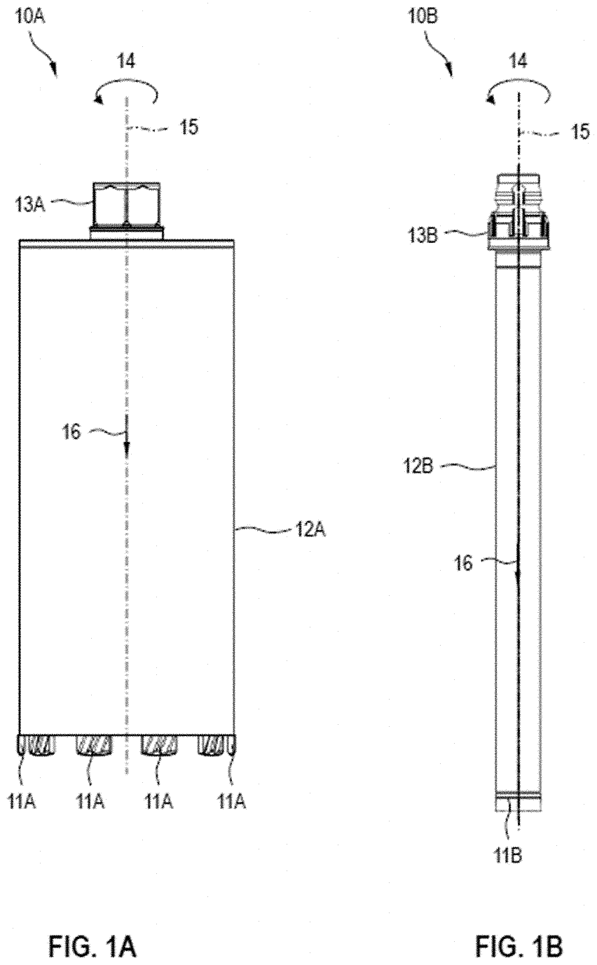

FIGS. 1A, B show two variants of a machining tool designed as a core drill bit 10A, 10B. The core drill bit 10A shown in FIG. 1A is referred to below as the first core drill bit, and the core drill bit 10B shown in FIG. 1B is referred to as the second core drill bit; in addition, the first and second core drill bits 10A, 10B are both included under the term “core drill bit”.

The first core drill bit 10A comprises a number of machining segments 11A, a tubular basic body 12A and a tool fitting 13A. The machining segments 11A that are used for core drilling are also referred to as drilling segments, and the tubular basic body 12A is also referred to as a drilling shaft. The drilling segments 11A are fixedly connected to the drilling shaft 12A, for example by screwing, adhesive bonding, brazing or welding.

The second core drill bit 10B comprises an annular machining segment 11B, a tubular basic body 12B and a tool fitting 13B. The annular machining segment 11B that is used for core drilling is also referred to as drilling ring, and the tubular basic body 12B is also referred to as a drilling shaft. The drilling ring 11B is fixedly connected to the drilling shaft 12B, for example by screwing, adhesive bonding, brazing or welding.

The core drill bit 10A, 10B is connected via the tool fitting 13A, 13B to a core drill and, in drilling operation, is driven by the core drill in a direction of rotation 14 about an axis of rotation 15. During the rotation of the core drill bit 10A, 10B about the axis of rotation 15, the core drill bit 10A, 10B is moved along a feed direction 16 into a workpiece to be machined, with the feed direction 16 running parallel to the axis of rotation 15. The core drill bit 10A, 10B creates a drill core and a borehole in the workpiece to be machined.

The drilling shaft 12A, 12B is of a one-piece form in the exemplary embodiment of FIGS. 1A, B, and the drilling segments 11A or the drilling ring 11B are fixedly connected to the drilling shaft 12A, 12B. Alternatively, the drilling shaft 12A, 12B may be of a two-piece form, composed of a first drilling shaft section and a second drilling shaft section, with the drilling segments 11A or the drilling ring 11B being fixedly connected to the first drilling shaft section, and the tool fitting 13A, 13B being fixedly connected to the second drilling shaft section. The first and second drilling shaft sections are connected to one another via a releasable connection device. The releasable connection device takes the form for example of a plug-and-twist connection as described in EP 2 745 965 A1 or EP 2 745 966 A1. The design of the drilling shaft as a one-piece or two-piece drilling shaft has no influence on the structure of the drilling segments 11A or of the drilling ring 11B.

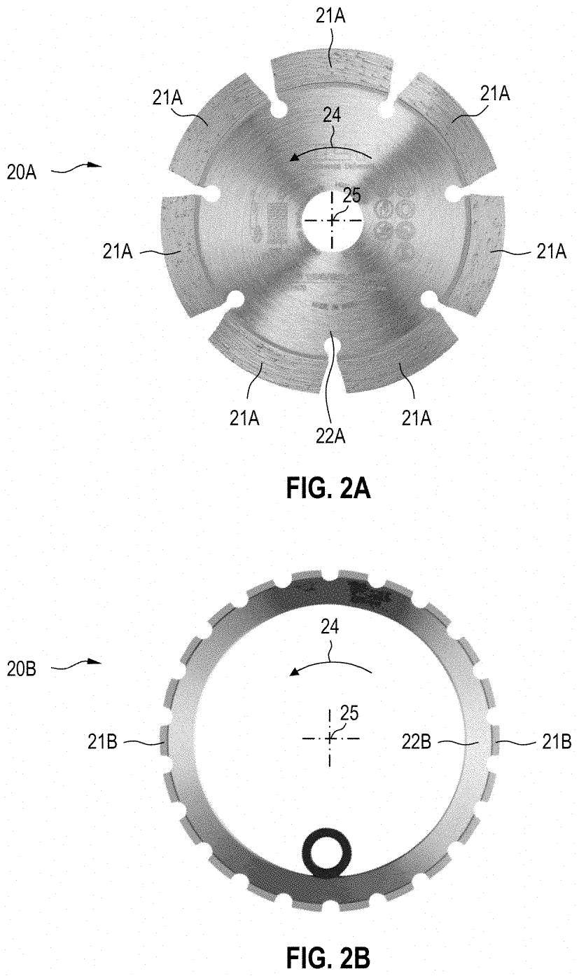

FIGS. 2A, B show two variants of a machining tool designed as a saw blade 20A, 20B. The saw blade 20A shown in FIG. 2A is referred to below as the first saw blade and the saw blade 20B shown in FIG. 2B is referred to as the second saw blade; in addition, the first and second saw blades 20A, 20B are both included under the term “saw blade”.

The first saw blade 20A comprises a plurality of machining segments 21A, a disk-shaped basic body 22A and a tool fitting. The machining segments 21A, which are used for sawing, are also referred to as sawing segments, and the disk-shaped basic body 22A is also referred to as a blade body. The sawing segments 21A are fixedly connected to the blade body 22A, for example by screwing, adhesive bonding, brazing or welding.

The second saw blade 20B comprises a plurality of machining segments 21B, an annular basic body 22B and a tool fitting. The machining segments 21B, which are used for sawing, are also referred to as sawing segments and the annular basic body 22B is also referred to as a ring. The sawing segments 21B are fixedly connected to the ring 22B, for example by screwing, adhesive bonding, brazing or welding.

The saw blade 20A, 20B is connected to a saw via the tool fitting and, in sawing operation, is driven by the saw in a direction of rotation 24 about an axis of rotation 25. During the rotation of the saw blade 20A, 20B about the axis of rotation 25, the saw blade 20A, 20B is moved along a feed direction, the feed direction running parallel to the longitudinal plane of the saw blade 20A, 20B. The saw blade 20A, 20B creates a sawing slit in the workpiece to be machined.

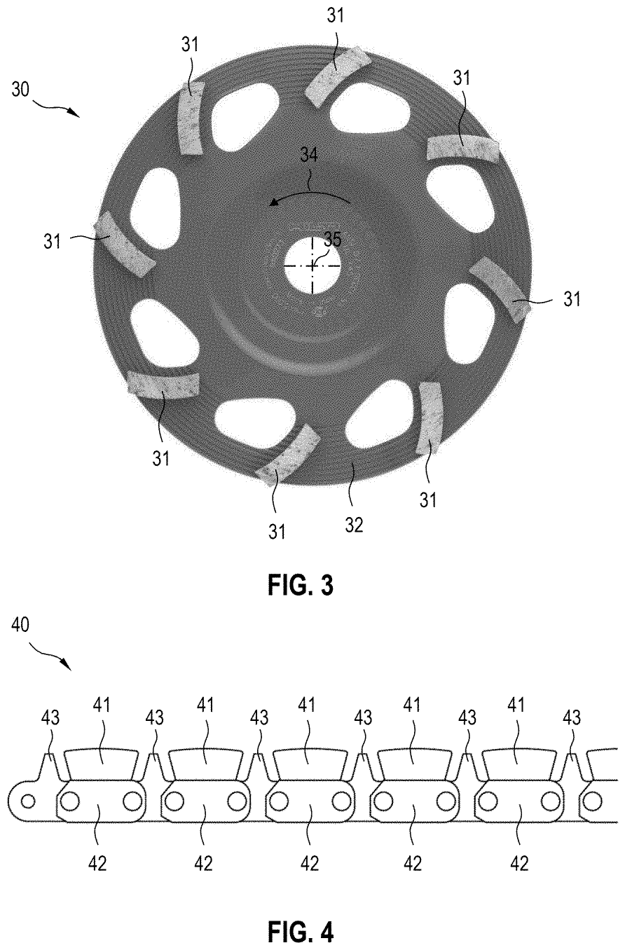

FIG. 3 shows a machining tool designed as an abrasive disk 30. The abrasive disk 30 comprises a number of machining segments 31, a basic body 32 and a tool fitting. The machining segments 31, which are used for abrasive removal, are also referred to as abrading segments, and the disk-shaped basic body 32 is also referred to as a pot. The abrading segments 31 are fixedly connected to the pot 32, for example by screwing, adhesive bonding, brazing or welding.

The abrasive disk 30 is connected via the tool fitting to a tool device and, in abrading operation, is driven by the tool device in a direction of rotation 34 about an axis of rotation 35. During the rotation of the abrasive disk 30 about the axis of rotation 35, the abrasive disk 30 is moved over a workpiece to be machined, the movement running perpendicular to the axis of rotation 35. The abrasive disk 30 removes the surface of the workpiece to be machined.

FIG. 4 shows a machining tool designed as a cut-off grinding chain 40. The cut-off grinding chain 40 comprises a number of machining segments 41, a number of basic bodies 42 in the form of links, and a number of connecting links 43. The machining segments 41, which are used for cut-off grinding, are also referred to as cut-off grinding segments, and the basic bodies 42 in the form of links are also referred to as driving links.

The driving links 42 are connected via the connecting links 43. In the exemplary embodiment, the connecting links 43 are connected to the driving links 42 via rivet bolts. The rivet bolts allow a rotation of the driving links 42 relative to the connecting links 43 about an axis of rotation which runs through the center of the rivet bolts. The machining segments 41 are fixedly connected to the driving links 42, for example by screwing, adhesive bonding, brazing or welding.

The cut-off grinding chain 40 is connected via a tool fitting to a tool device and, in operation, is driven by the tool device in a direction of rotation. During the rotation of the cut-off grinding chain 40, the cut-off grinding chain 40 is moved into a workpiece to be machined.

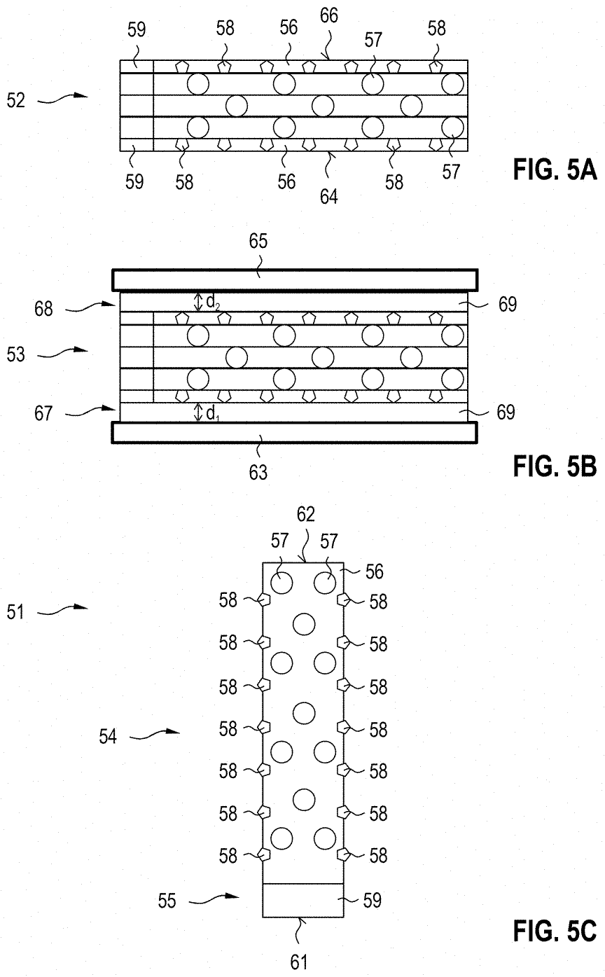

The production of a machining segment 51 (see, e.g. FIGS. 5A-C) that has low wear on the side surfaces takes place by means of the method according to the invention for producing a machining segment in three stages: in a first stage, a green body 52 is produced; in a second stage, the green body 52 is compacted to form a compact body 53 and, in a third stage, the compact body 53 is further processed to form the machining segment 51.

FIGS. 5A-C show the green body 52 (FIG. 5A), the compact body 53 (FIG. 5B) and the machining segment 51 (FIG. 5C). The machining segment 51 is built up from a machining zone 54 and a neutral zone 55. The neutral zone 55 is required if the machining segment 51 is to be welded to the basic body of a machining tool and the combination of matrix material and basic body cannot be welded; in the case of weldable combinations of matrix material and basic body, there in no need for the neutral zone 55.

The machining zone 54 is built up from a powdered or granular first matrix material 56, first hard material particles 57, which are arranged according to a defined first particle pattern, and second hard material particles 58, which are arranged according to a defined second particle pattern, and the neutral zone 55 is built up from a powdered or granular second matrix material 59. The term “matrix material” covers all materials for building up machining segments in which hard material particles can be embedded. Matrix materials may consist of one material or be composed as a mixture of different materials. The term “hard material particles” covers all cutting agents for machining segments; these especially include individual hard material particles, composite parts made up of multiple hard material particles and coated or encapsulated hard material particles.

The machining segment 51 corresponds in structure and composition to the machining segments 11A, 21A, 21B, 31, 41; the machining segment 11B designed as a drilling ring differs from the machining segment 51 by its annular structure. The machining segments can differ from one another in the dimensions and in the curvatures of the surfaces. The structure of the machining segments is explained on the basis of the machining segment 51 and applies to the machining segments 11A, 21A, 21B, 31, 41.

The machining segment 51 comprises the first and second hard material particles 57, 58, which are arranged in the first matrix material 56. “First hard material particles” refer to those hard material particles of the machining segment 51 that machine a substrate, the number of the first hard material particles 57 and the defined first particle pattern being adapted to the requirements of the machining segment 51. Depending on the wear properties of the first matrix material 56, increased wear of the first matrix material 56 on the side surfaces of the machining segment 51 can occur during the machining of a substrate with the machining segment 51 as a result of friction with the substrate. This wear is reduced by the second hard material particles 58.

The first hard material particles 57 and second hard material particles 58 generally originate from particle distributions which are characterized by a minimum diameter, a maximum diameter and an average diameter. In the exemplary embodiment of FIGS. 5A-C, the first hard material particles 57 originate from a first particle distribution with a first average diameter and the second hard material particles 58 originate from a second particle distribution with a second average diameter, the first average diameter being greater than the second average diameter. Alternatively, the first hard material particles 57 and second hard material particles 58 may originate from the same particle distribution and have the same average diameter.

The machining segment 51 is connected by an underside 61 to the basic body of a machining tool. In the case of the machining segment 51 shown in FIG. 5C, the first hard material particles 57 are arranged according to the defined first particle pattern in a plurality of particle layers in the first matrix material 56 and the second hard material particles 58 are arranged according to the defined second particle pattern on the side surfaces of the machining segment 51. The substrate is machined by first hard material particles 57, which are arranged on an upper side 62 opposite from the underside 61 of the machining segment 51.

The green body 52 shown in FIG. 5A is built up horizontally from the first matrix material 56, the first hard material particles 57, the second hard material particles 58 and the second matrix material 59. The green body 52 is compacted under the action of pressure between a first press punch 63, which forms a first side surface 64 of the green body 52, and a second press punch 65, which forms a second side surface 66 of the green body 52. In this case, the pressing direction between the first press punch 63 and the second press punch 65 runs parallel to the building-up direction of the green body 52. Examples of suitable methods for achieving an action of pressure on the green body 52 are cold-pressing methods or hot-pressing methods. In the case of cold-pressing methods, the green body 52 is exclusively subjected to an action of pressure, while in the case of hot-pressing methods the green body 52 is subjected not only to the action of pressure but also to an action of temperature up to temperatures of about 200° C.

When the green body 52 is compacted, a first film 67 with a first layer thickness d₁ is arranged between the first press punch 63 and the green body 52 and a second film 68 with a second layer thickness d₂ is arranged between the second press punch 65 and the green body 52. The first film 67 and second film 68 consist of a film material 69, which is different from the first matrix material 56. The film material 69 has a hardness which is less than the hardness of the first matrix material 56. Because the hardness of the film material 69 is less than the hardness of the first matrix material 56, when compacting between the first press punch 63 and second press punch 65, the projection of the second hard material particles 58 is created on the first side surface 64 and second side surface 66. The method according to the invention has the advantage that the projection of the second hard material particles is created during the production of the machining segment and no re-working of the machining segments on the side surfaces is required.

In the case of the compact body 53 shown in FIG. 5B, the first film 67 and second film 68 are removed after compaction and the compact body 53 is further processed to form the machining segment 51 by free-form sintering. During free-form sintering, the compact body 53 is heated up until the sintering temperature of the first matrix material 56 and the sintering temperature of the second matrix material 59 are reached; no further shaping takes place. The machining segment 51 has attained its final geometry when the green body 52 is compacted between the first press punch 63 and second press punch 65.

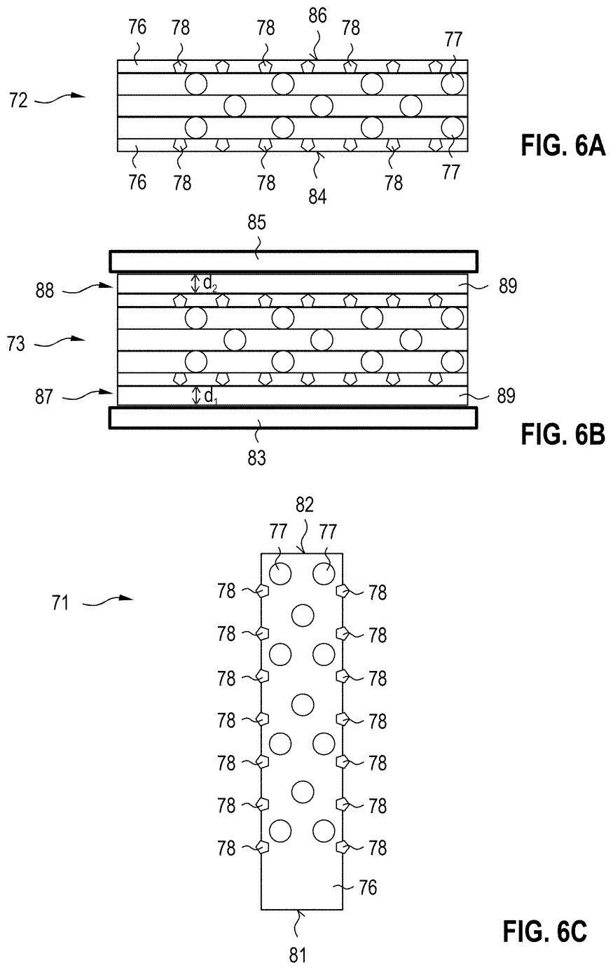

FIGS. 6A-C show another machining segment 71, produced by an alternative variant of the method according to the invention for producing a machining segment. The machining segment 71 is produced in three stages: in a first stage, a green body 72 is produced (FIG. 6A), in a second stage, the green body 72 is compacted to form a compact body 73 (FIG. 6B) and, in a third stage, the compact body 73 is further processed to form the machining segment 71 (FIG. 6C).

The machining segment 71 differs from the machining segment 51 of FIG. 5C by the fact that the machining segment 71 has no neutral zone. The machining segment 71 is built up from a first matrix material 76, first hard material particles 77 and second hard material particles 78. The first hard material particles 77 are arranged according to a defined first particle pattern and the second hard material particles 78 are arranged according to a defined second particle pattern.

The first hard material particles 77 generally originate from a first particle distribution with a first average diameter and the second hard material particles 58 originate from a second particle distribution with a second average diameter. In the exemplary embodiment of FIGS. 6A-C, the first hard material particles 77 and second hard material particles 78 originate from the same particle distribution and have the same average diameter.

The machining segment 71 is connected by an underside 81 to the basic body of a machining tool. In the case of the machining segment 71 shown in FIG. 6C, the first hard material particles 77 are arranged according to the defined first particle pattern in a plurality of particle layers in the first matrix material 76 and the second hard material particles 78 are arranged according to the defined second particle pattern on the side surfaces of the machining segment 71. The substrate is machined by first hard material particles 77, which are arranged on an upper side 82 opposite from the underside 81 of the machining segment 71.

The green body 72 shown in FIG. 6A is built up from the first matrix material 76, the first hard material particles 77 and the second hard material particles 78. The green body 72 is compacted under the action of pressure between a first press punch 83, which forms a first side surface 84 of the green body 72, and a second press punch 85, which forms a second side surface 86 of the green body 72.

When the green body 72 is compacted, a first film 87 with a first layer thickness d₁ is arranged between the first press punch 83 and the green body 72 and a second film 88 with a second layer thickness d₂ is arranged between the second press punch 85 and the green body 72. The first and second films 87, 88 consist of a film material 89, which is different from the first matrix material 76. The film material 89 has a hardness which is less than the hardness of the first matrix material 76. Because the hardness of the film material 89 is less than the hardness of the first matrix material 76, when compacting between the first press punch 83 and second press punch 85, the projection of the second hard material particles 78 is created on the first side surface 84 and second side surface 86.

In the case of the compact body 73 shown in FIG. 6B, the first film 87 and second film 88 are not removed after compaction and the compact body 73 with the first and second films 87, 88 is further processed by sintering to form the machining segment 71. The properties of the film material 89, in particular the melting temperature Tₘₑₗₜ or the flash point T_{flame} of the film material 89, determine the behavior of the film material 89 during sintering.

If the melting temperature Tₘₑₗₜ of the film material 89 is lower than the sintering temperature Tₛᵢₙₜₑᵣ of the first matrix material 76, when the compact body 73 is heated up the film material 89 melts before the first matrix material 76 has reached its sintering temperature Tₛᵢₙₜₑᵣ; the liquid film material 89 distributes itself in the first matrix material 76 during the sintering process and can support the sintering process as an infiltrate. If the flame point T_{flame} of the film material 89 is lower than the sintering temperature Tₛᵢₙₜₑᵣ of the first matrix material 76, when the compact body 73 is heated up the film material 89 evaporates before the first matrix material 76 has reached its sintering temperature Tₛᵢₙₜₑᵣ.

What is claimed is:

1.-6. (canceled)

7. A method for producing a machining segment for a machining tool from a powdered or granular first matrix material, first hard material particles arranged according to a defined first particle pattern, and second hard material particles arranged according to a defined second particle pattern, the machining segment being connected by an underside to a basic body of the machining tool, the method comprising the following steps:
building up a green body from the first matrix material, the first hard material particles and the second hard material particles, wherein the first hard material particles are arranged in the first matrix material according to the defined first particle pattern and the second hard material particles are arranged in the first matrix material according to the defined second particle pattern;
compacting the green body under the action of pressure between a first press punch forming a first side surface of the green body, and a second press punch forming a second side surface of the green body, to form a compact body; and
further processing the compact body under the action of temperature to form the machining segment;
wherein, when compacting the green body, a first film of a film material is arranged between the first press punch and the green body and a second film of the film material is arranged between the second press punch and the green body, wherein the film material has a hardness less than the hardness of the first matrix material.

8. The method as recited in claim 7 wherein the second hard material particles are completely embedded in the first matrix material on the upper side when the green body is built up.

9. The method as recited in claim 7 wherein the first film and second film are removed from the compact body after compaction.

10. The method as recited in claim 7 wherein the compact body with the first film and second film is further processed to form the machining segment.

11. The method as recited in claim 10 wherein the melting temperature of the film material is lower than the sintering temperature of the first matrix material.

12. The method as recited in claim 10 wherein the flash point of the film material is lower than the sintering temperature of the first matrix material.
